(19) United States
(12) Patent Application Publication
(10) Pub. No.: US 2025/0214243 A1
(43) Pub. Date: Jul. 3, 2025

(54) High Precision Pick and Place Operation

(71) Applicant: Bright Machines, Inc., San Francisco, CA (US)

(72) Inventors: Emmanuel Gallo, Oakland, CA (US); Ali Shafiekhani, San Francisco, CA (US); Pattawong Pansodtee, Mountain View, CA (US); Barrett Christopher Clark, Atlanta, GA (US); Murali Pappoppula, Fremont, CA (US)

(21) Appl. No.: 19/001,348

(22) Filed: Dec. 24, 2024

Related U.S. Application Data
(60) Provisional application No. 63/616,506, filed on Dec. 29, 2023.

(51) Int. Cl. B25J 9/16; G06T 7/73

(52) U.S. Cl. CPC B25J 9/1687; B25J 9/1692; B25J 9/1697; G06T 7/74; G06T 2207/10028; G06T 2207/30108

(57) ABSTRACT

An assembly operation and a robotic cell for inserting a part into a chassis comprising calculating a first part pose estimation for the part in the pick area, picking up the part, and moving the part above the chassis, calculating a second part pose estimation for the part being held by the robot arm above the chassis, and correcting the second part pose estimation using a chassis pose estimation. The operation further comprising inserting the part into the chassis, wherein the multi-stage verification ensures that a high value part is not damaged in the assembly.

### RELATED CASES

The present application claims priority to U.S. Provisional Application 63/616,506 filed on Dec. 29, 2023, and incorporates that application in its entirety by reference.

### FIELD

The present invention relates to robotic assembly, and more particularly to high precision pick and place operations.

### BACKGROUND

Pick and place operations use a robotic arm with an end-of-arm component to insert elements into a board, such as heat sinks and CPUs, in assembling various types of devices.

### BRIEF DESCRIPTION OF THE FIGURES

The present invention is illustrated by way of example, and not by way of limitation, in the figures of the accompanying drawings and in which like reference numerals refer to similar elements and in which:

FIG. 1A is a top view of one embodiment the work area, showing the pick area and the place area, as well as the position of the imaging elements.

FIG. 1B is a block diagram of one embodiment of the pick & place system.

FIG. 2A is an overview flowchart of one embodiment of the process.

FIG. 2B is a flowchart of one embodiment of three dimensional pose estimation.

FIG. 2C is an overview flowchart of one embodiment of the system in use.

FIG. 3A is a flowchart of one embodiment of the pick operation.

FIG. 3B illustrates one exemplary picking operation, picking a Multi-GPU board from a box.

FIG. 3C illustrates an exemplary point cloud that may be generated by the system, showing a Multi-GPU board in a box, prior to pick up.

FIG. 3D illustrates an exemplary reduced point cloud, showing the Multi-GPU board, but having removed the irrelevant data of the box, and the portion of the point cloud below the working surface.

FIG. 4A-4B are a flowchart of one embodiment of the place operation.

FIG. 4C illustrates an exemplary placement operation, with the robotic end of arm moving the Multi-GPU board toward the chassis.

FIG. 4D illustrates an exemplary placement operation stopping point, with the Multi-GPU board placed above the chassis.

FIGS. 4E and 4F illustrate a point cloud and the updated point cloud cropping irrelevant points.

FIG. 5A is a flowchart of one embodiment of the final position correction just before insertion.

FIG. 5B illustrates a perspective view, showing the robotic arm as well as the chassis and a region of interest.

FIG. 6 is a flowchart one embodiment of calibration validation.

FIG. 7 is a block diagram of one embodiment of a computer system that may be used with the present invention.

### DETAILED DESCRIPTION

A high precision pick & place system utilizes a high accuracy pick and place operation, to place expensive elements. For example, the pick & place system may be used to place a GPU (graphics processing unit) into a chassis. The system may also be used to place a CPU (central processing unit), a Multi-GPU board, or any other high value component, where the additional time for accuracy is worth the reduced risk that a part would be damaged during insertion. The precision pick & place (PPP) system is designed to implement an assembly process in which there is zero scrap, for high value board or element placement. The system relies on a multi-sensor system that provides continuous detection and validation.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

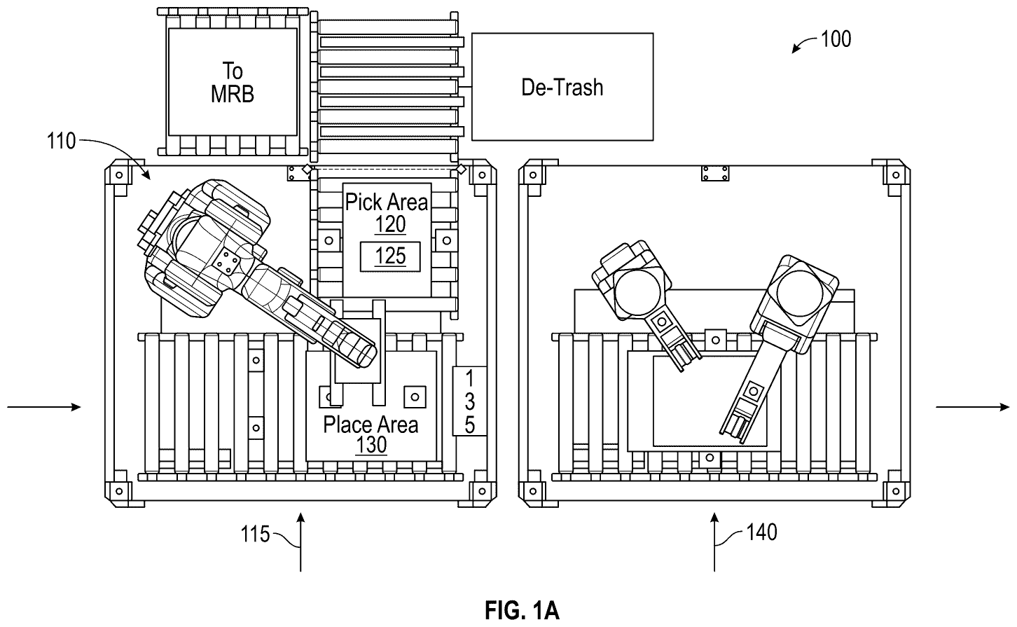

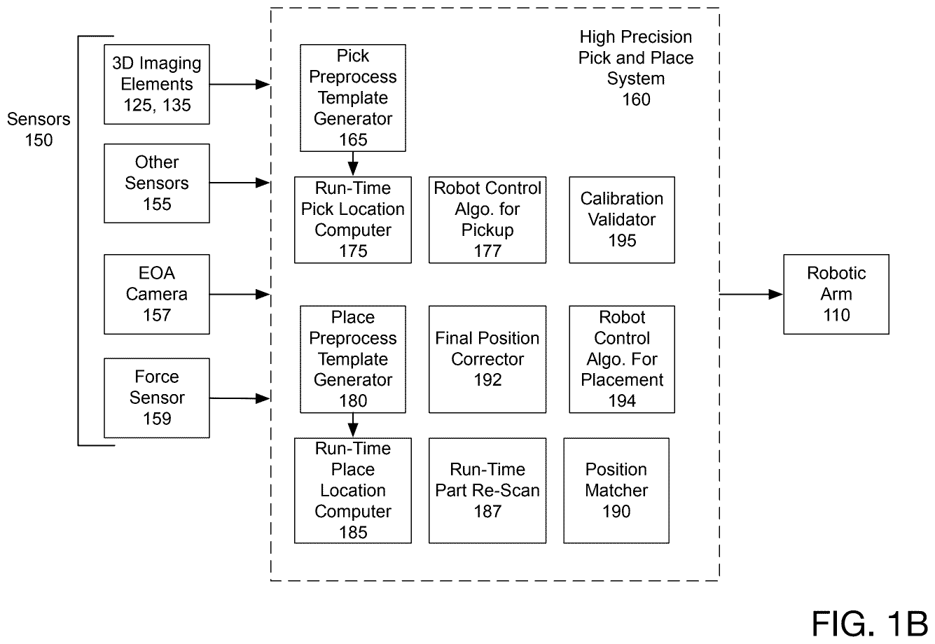

FIG. 1A illustrates a top view of one embodiment of the system. The system 100 illustrates the robotic arm 110 in a workspace of a robotic cell 115, which includes a pick area 120 and a place area 130. The pick area 120 in one embodiment has a first three-dimensional imaging element 125 placed above it. In one embodiment, the three dimensional imaging element 125 is affixed to the robotic cell enclosure. In one embodiment, a second three-dimensional imaging element 135 is placed above the place area 130. In one embodiment, the three-dimensional imaging elements 125, 135 are structured light sensors, such as the ones made by Photoneo™. In another embodiment, alternative sensors may be used. For example, in one embodiment, the three-dimensional imaging element 125, 135 may be two or more 2D (two dimensional) cameras, or a single 2D camera with an associated machine learning system to infer absolute depth. In one embodiment a time-of-flight sensor may be used as the three-dimensional imaging elements.

In the illustrated configuration of FIG. 1A, in addition to the first cell 115 including robotic arm 110 which picks up an element from the pick area 120 and places it on a board in the place area 130, a second robotic cell 140 is illustrated. The second robotic cell 140 in one embodiment attaches the piece placed by the first robotic cell. The attachment may be using screws, or another mechanism. For example, the first cell may place a GPU into a chassis, while the second cell may attach the GPU using screws or another attachment mechanism.

In one embodiment, the second robotic cell 140 may use a similar process to ensure that the attachment is precise, using a single sensor for its single working area. In one embodiment, the use of the sensor and the multi-stage process enables the accurate attachment of a heavier component like a Multi-GPU board even when the component is heavy enough to deform the board/chassis. In one embodiment, a robotic assembly line, or micro-factory may include one, two, or more robotic cells in sequence, each of which performs one or more tasks. In one embodiment, the micro-factory includes a first robotic cell to open a drawer in the chassis, into which the Multi-GPU board is inserted, the second robotic cell to insert the Multi-GPU board into the chassis, and a third robotic cell to close the drawer. If separate attachment is needed, there may be a four-cell microfactory, in which a first cell opens a drawer or opens the socket, a second cell places the component into the socket, a third cell fastens the component into location, and the fourth cell closes the drawer or socket. Furthermore, additional cells may be part of the microfactory to attach other components to the chassis or board.

In another embodiment, a single robotic cell may perform multiple actions. For example, a single robotic cell may pick and place as well as attach a component. In one embodiment, in this configuration, the robotic cell includes a tool changer which changes the end of arm tool between the operations.

FIG. 1B is a block diagram of one embodiment of the pick & place system. The pick and place system 160 receives data from sensors 150, which include in one embodiment 3D imaging elements 125, 135, and/or other sensors 155. In one embodiment, the system uses two 3D (three dimensional) imaging elements 125, 135, one for picking and one for placing an element. One embodiment of locations for the imaging elements are shown in FIG. 1A. Alternative placements may also be used. The other sensors 155 may include cameras, depth sensors, force sensors, contact sensors, or other sensing systems. In one embodiment, the other sensors may include a structured light sensor, two-dimensional stereo cameras, one or more two dimensional cameras with a machine learning system to compute depth. In one embodiment, an end of arm camera 157 is also included in the sensors 150. In one embodiment, one (or two) cameras are used for final position correction just before insertion. Cameras may be placed on the middle of the end of arm tool (EOAT), in one embodiment.

In one embodiment, imaging elements 125, 135 are used for validating the calibration, and for providing auto-correction if the calibration is not accurate. In one embodiment, the sensors 150 may also include a force sensor 159, which detects the force level when the part is inserted into the chassis. The force sensor 159 in one embodiment, also monitors the force while the part is being moved by the robotic arm. This may be used to detect if there is interference with the movement of the robotic arm.

The high precision pick and place system 160 in one embodiment is implemented by a processing system including one or more processors and memory. In one embodiment, the processing system may be part of a robotic cell. In another embodiment, the processing system may be remote from the robotic cell and accessed via a network. In one embodiment, portions of the processing may be distributed between a local processor and a remote processor, both of which are part of the processing system. In one embodiment, template generation occurs on a remote processor while run-time processing occurs on the local device which is part of the robotic cell. In one embodiment, a cloud-based processing system may be used, which distributes processing among a plurality of processors and devices.

The high precision pick and place system 160 includes a pick pre-process template generator 165, which utilizes data from the sensors 150 to generate a template for the component being picked up. The template defines the size and shape of the component. In one embodiment, the template defines the orientation and dimensions of the component to be inserted, which also defines the relevant elements of the component. In one embodiment, the relevant elements include grasping points used to pick up the part. For insertion of a Multi-GPU board into a chassis, in one embodiment, the template is used to identify the locations of the handles of the Multi-GPU board, which are used to support the Multi-GPU board. In one embodiment, the system uses a point cloud matched to a template to compute the positions/locations of elements. In one embodiment, an iterative closest point (ICP) algorithm is used, along with a rough location, to compute precise positions/locations of elements. In one embodiment, the pick preprocess template generator 165 may generate the template offline, prior to initiating the robotic cell. In one embodiment, the pick preprocess template generator may receive a template generated offline.

The run-time pickup location computer 175 utilizes a point cloud to match the actual position and configuration of the component being picked up to the template, to define the location of the grasping points.

The defined location is used to provide navigation data to the robot control algorithm for pickup 177, which moves the robotic arm to pick up the component. The accuracy of this pickup algorithm is important to ensure that the component is not damaged when it is picked up. Especially for large and heavy components like multi-GPU boards, the amount of force exerted on the component to pick it up and carry it is high. The robot control algorithm has high accuracy in picking up the component, as well as moving it safely without joggling it or dropping it and lowering it without risk.

The component is then moved to the place portion of the robotic cell, preparing the component to be placed in a chassis, socket, drawer, or another receptacle.

The place pre-process template generator 180 generates a template of the chassis or socket. In one embodiment, this may be done offline, prior to initiating the robotic cell. In one embodiment, the place pre-process template generator may receive the template generated offline.

The run-time place location computer 185 in one embodiment performs computations when the chassis/board arrives, to match the template to the actual chassis/board position. The run-time place location computer 185 also performs computations when the component to be inserted into the board/chassis arrives, to match the component to the chassis/board.

The run-time part re-scan 187 in one embodiment generates a point cloud when the component for insertion is positioned above the chassis, held by the end of arm tool. This is used to validate the configuration of the part, as it is held by the robotic end of arm tool. It enables correction for the part pose, accounting for jogging of the part during the movement, which would move it out of alignment. It also enables correction for small deviations such as small amount of twisting or warping of the component.

Position matcher 190 matches the run-time location of the chassis determined by the run-time place location computer 185 with the pose and position of the component determined by the run-time part scan 187. The data from the position matcher 190 is used by the robot control algorithm for placement 194 to control the robotic arm and end of arm tool to insert the component into the chassis/socket.

In one embodiment, before insertion of the component, the final position corrector 192 uses a region-of-interest based template matching to compute the distance between alignment pins and the motherboard holes, to ensure that the component and chassis/board are correctly aligned.

During insertion by robot control algorithm for placement 194, the force sensor 159 is used to monitor the force needed for the insertion, in one embodiment. If the force is above a threshold, the insertion is stopped to ensure that the part is not damaged. This provides another safety mechanism for the system.

In one embodiment, calibration validator 195 verifies that the robotic system remains in calibration. The calibration validator 195 in one embodiment uses a validator template of the fixed portions of the robotic arm to perform a transformation between the validator template and a current scan of the workspace. The transformation is identity (e.g., the two are identical) when the system remains in calibration. If the transformation is not identity, e.g., there is calibration issue, the calibration validator in one embodiment can automatically apply a correction to ensure that the placement is accurate. The various components and computers described in the high precision pick and place system 160 may be separate software applications resident on a single processing system, on a distributed processing system that is local or remote from the robotic cell, or on two or more processing systems which include one or more processors.

In this way, the high precision pick and place system 160 can be used to insert high value items into a board, with high accuracy and without risking damaging of the high value items.

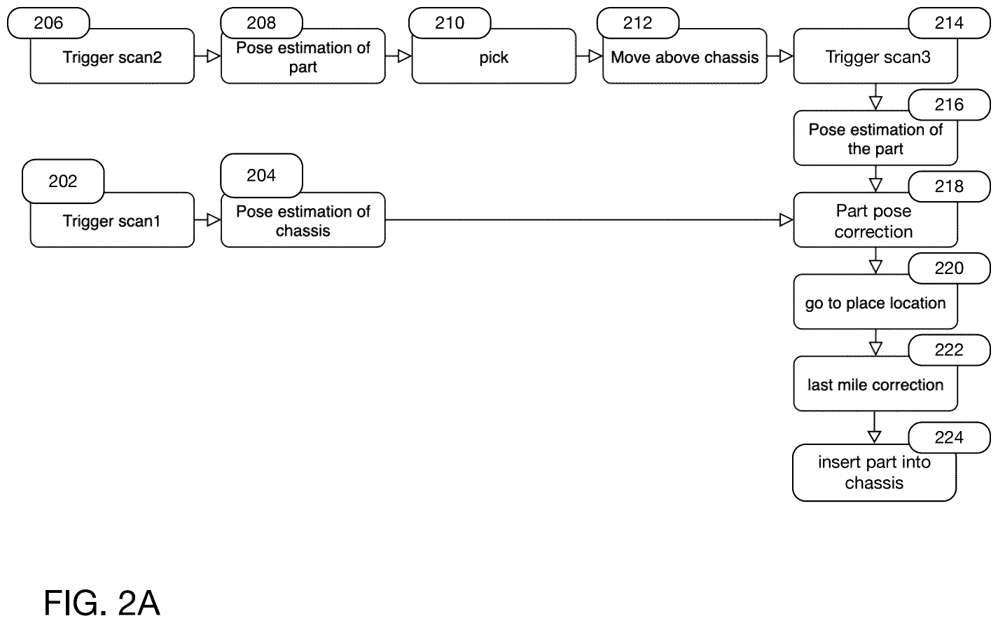

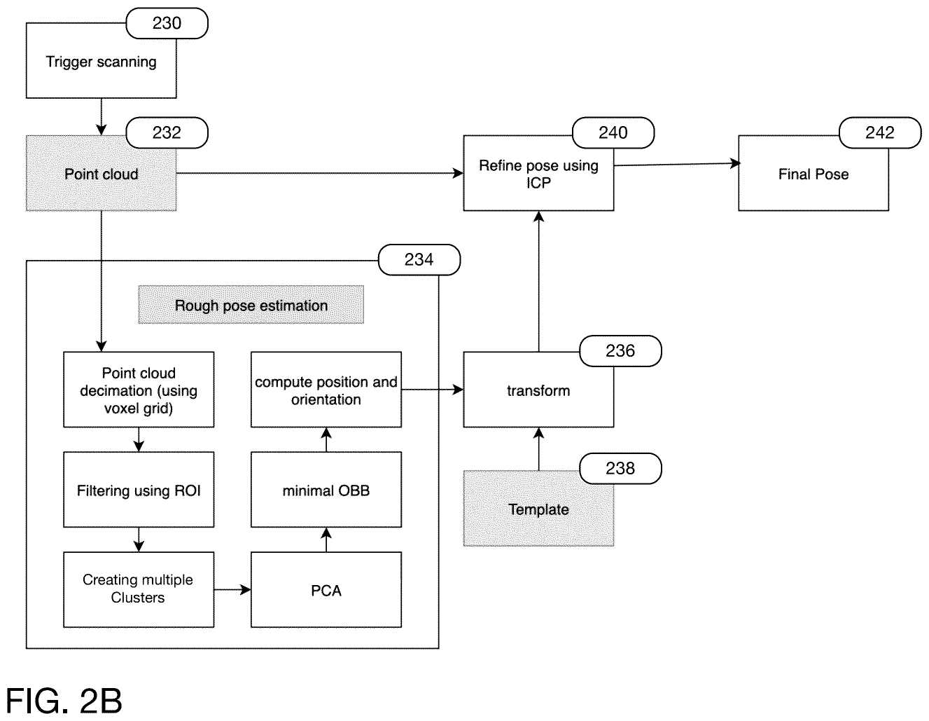

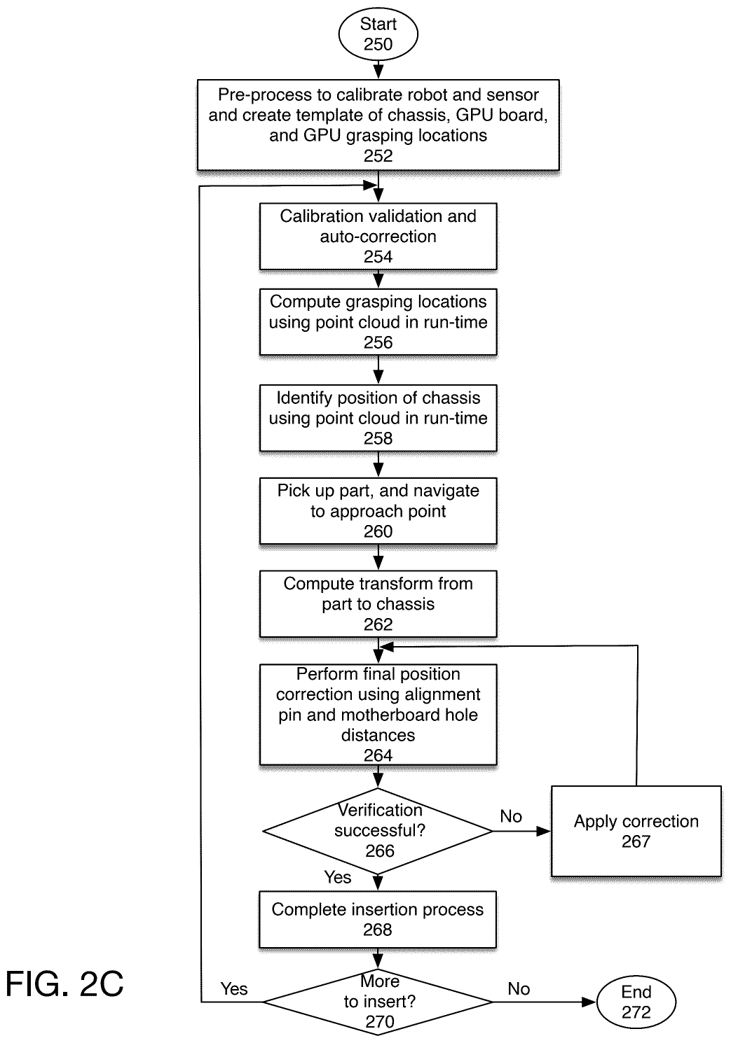

FIG. 2A is an overview flowchart of one embodiment of the insertion process. The first scan is triggered (block 202) to obtain a point cloud, which is used in the pose estimation of the chassis (block 204). The second scan (block 206) is used for pose estimation of the part or component for insertion into the chassis (block 208). The first and second scans and pose estimations may be executed concurrently, or in any order. In one embodiment, the second scan (block 206) of the part is executed first, so the part can be picked up by the robotic arm for insertion, while the calculations from the first scan for the chassis are made.

After the pose estimation of the part is obtained, the part is picked up by the robotic arm (block 210) and moved above the chassis (block 212). The part is positioned above chassis in the alignment for insertion, in one embodiment. In one embodiment, this position is referred to as the approach point.

Another scan of the part at the approach point above the chassis is triggered (block 214). This scan in one embodiment is done by the same sensor that did the chassis trigger scan at block 202, since the approach point is in the “place” area of the robotic cell, in close proximity to the chassis.

A pose estimation of the part above the chassis is calculated (block 216). A comparison between the pose estimation of the part and the pose estimation of the chassis is performed, to determine whether the actual part pose matches the intended part pose which is matched to the chassis position and orientation. If not, the comparison is used to create a part pose correction (block 218). The part is then moved, if needed, to be correctly aligned with the chassis (block 220). Final position correction is applied, verifying the position of the part using a region of interest on the board/chassis (block 222). In one embodiment, final position correction matches an alignment pin and a mother board hole, to confirm that the part is in the correct position. Once any needed final position correction is applied, the insertion is completed, inserting part into the chassis (224). In one embodiment, during insertion the system utilizes a force sensor and/or other sensors, to ensure that the insertion is smooth, and the component is not damaged during insertion.

FIG. 2B is a flowchart of one embodiment of three dimensional pose estimation. This pose estimation may be used for the part pose estimations, and the chassis pose estimation, described above with respect to FIG. 2A.

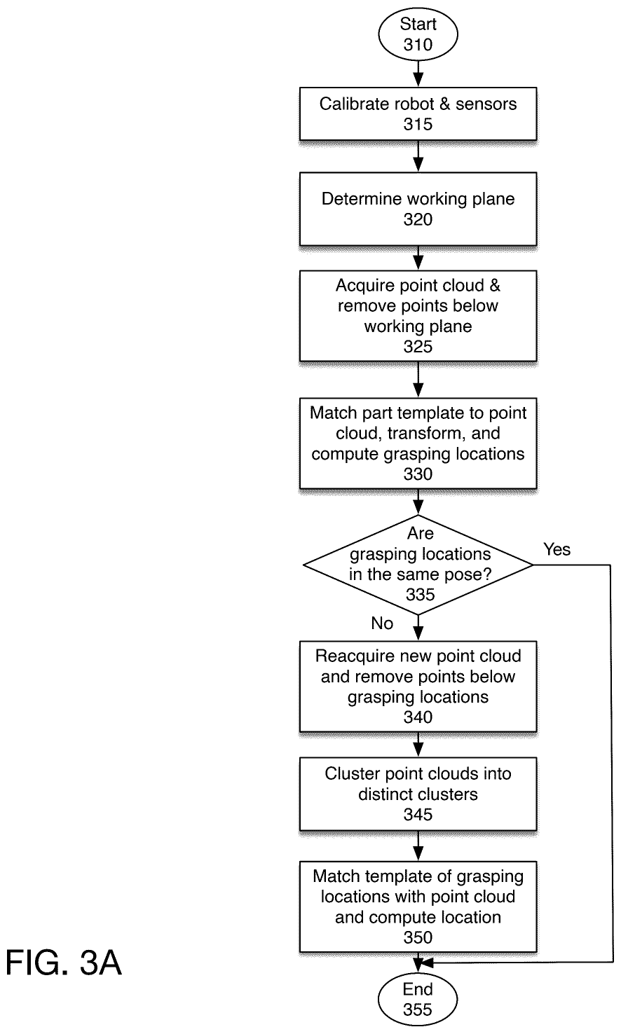

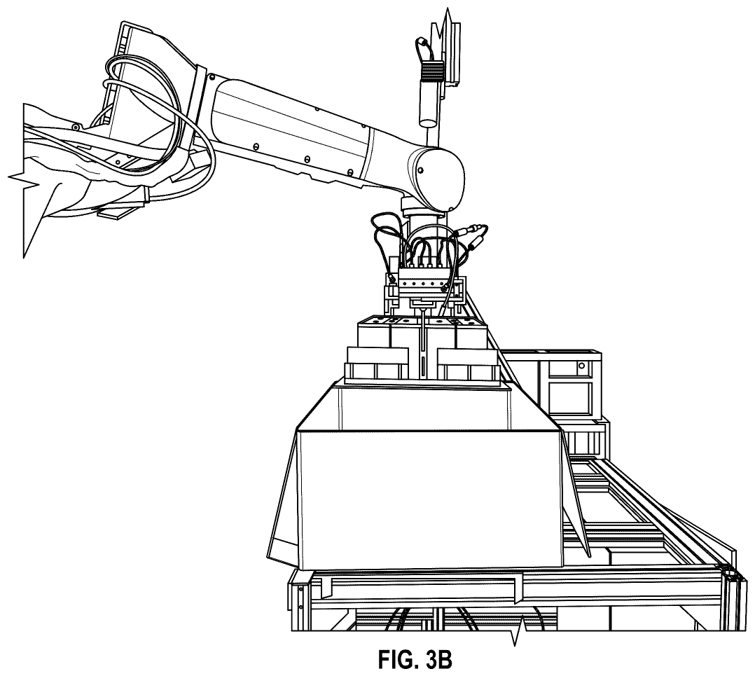

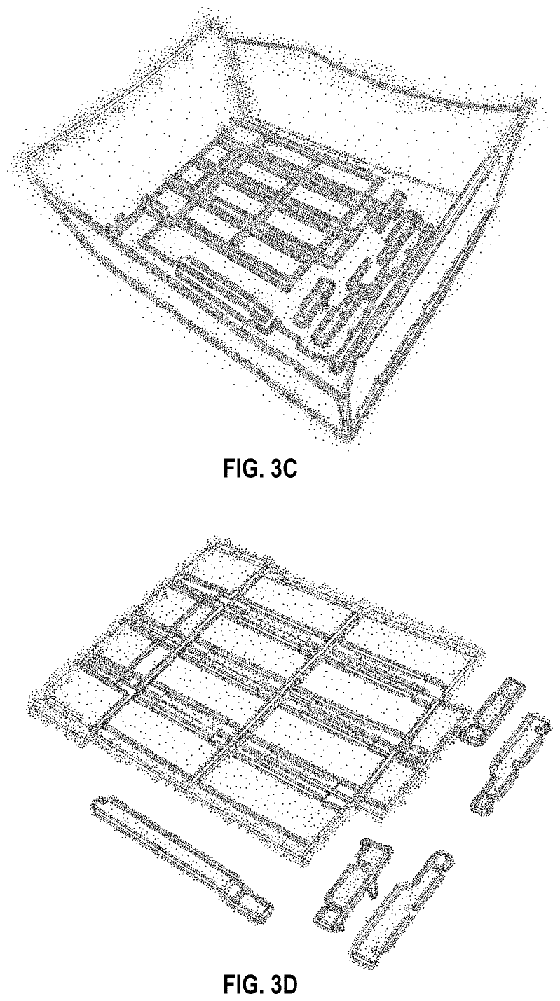

Scanning is initially triggered (block 230). The scanning produces a point cloud (block 232). The point cloud is used for rough pose estimation (block 234). An exemplary illustration of the point cloud that is generated is shown in FIG. 3C.

The point cloud is decimated, to reduce its size, and remove irrelevant points. In one embodiment, a voxel grid is used for decimation. Because this is for the rough estimate, the full point cloud is not needed. By decimating the point cloud, the processing is speeded up significantly. In one embodiment, the decimation reduces the point cloud density, lowering its resolution. In one embodiment, the resolution is lowered from an initial 0.5 mm to 3 mm. In one embodiment, the resolution is lowered by a factor of 5 to 20. This results in faster processing time, without loss of needed accuracy.

The decimated point cloud is filtered, using the defined regions of interest. In one embodiment, the regions of interest are defined by the part and the chassis. In one embodiment, the regions of interest are narrower, and defined by the gripping areas of the part, or the insertion areas of the chassis. The remaining points in the point cloud are then clustered. In one embodiment, the dbscan algorithm is used for clustering. In one embodiment, the largest clusters correspond to the regions of interest, e.g., the gripping areas for the part and the insertion areas for the chassis. Then principal component analysis (PCA) is applied to determine the orientation of the element from the clusters. In one embodiment, a minimal oriented bounding box (OBB) is applied, to find the oriented minimum bounding box enclosing the set of points. Based on the bounding box and the PCA, the position and orientation of the element is determined.

The output of rough pose estimation 234, provides a rough estimate of the pose {position and orientation} of the element. This pose is used as a transformation matrix (block 236), and it is applied to the element template 238 to be close to the real pose. In one embodiment, the comparison uses the full resolution point cloud for the transformation.

The transformed pose is then refined using an algorithm to match the two clouds of points (block 240), producing the final pose (242). In one embodiment, the algorithm is iterative closest point (ICP). The final pose is used to guide the robotic arm for picking up and placing the part in the chassis.

FIG. 2C is an overview flowchart of one embodiment of the system in use. The process starts at block 250. At block 252, the pre-processing is done. The pre-processing includes calibrating the robot and sensors and creating templates. The template creation may be done in parallel for the part and the socket where the part is inserted. The template creation may be done offline, or at a different time, in one embodiment.

At block 254, the robotic cell's calibration is validated. If the validation indicates that there is an issue with the calibration of the robotic cell, a correction is applied to account for the difference. In one embodiment if the discrepancy is above a threshold, the robotic cell is recalibrated.

At block 256, the grasping locations of the part are calculated using a point cloud. In one embodiment, the system uses the point cloud to identify the position and orientation of the part and calculates the grasping locations based on the determination and the template for the part. The grasping locations are the points which the robotic arm uses to pick up and move the part. In one embodiment, for heavier parts, the grasping locations are reinforced to allow the robotic arm to safely move the part.

At block 258, the position and orientation of the chassis (or socket) is identified using a point cloud. In one embodiment, the determination uses a combination of image data from one or more sensors and the chassis template.

At block 260, the part is picked up and brought to the approach point for the chassis. In one embodiment, after the part is picked up and brought to close proximity with the chassis, a second point cloud is used to verify the pose and orientation of the part being held by the robotic arm.

At block 262, a transform from the part to the chassis is computed. In one embodiment, the transform is used for motion path planning to move the part to the appropriate location with respect to the chassis. The part is then lowered toward the chassis, using the computed transformation. In one embodiment, the part is stopped just above the chassis. In one embodiment, the stopping point is just above an alignment pin. This point is referred to as the approach point.

At block 264, the final position correction just before insertion is applied. In one embodiment, the final position correction uses an alignment pin and motherboard hole distances, to verify the position and orientation of the part, to ensure that it matches the position and orientation of the chassis.

At block 266, the process determines whether the verification was successful. If the verification was not successful, at block 267 correction is applied, and the process returns to block 264.

If the verification was successful, the insertion process is completed at block 268. In one embodiment, a force sensor is also used during the insertion process to ensure that the insertion is smooth, and the system does not apply too much force to the part or the chassis. In one embodiment, if the force is above a threshold, the system stops the insertion and recalculates prior to re-attempting the insertion. In one embodiment, if the force is above the threshold, the part may be lifted back up and the robot arm may return to the approach point, and to block 260 to restart the insertion.

Once the insertion process is completed at block 268, the process determines whether there are more parts to insert at block 270, in one embodiment. If so, the process returns to block 254. In one embodiment, the process returns to block 256, and the calibration validation occurs periodically independently of the insertions, or on some other schedule. If there are no more parts to insert, the process ends at block 272. The process ends with the board, now including the inserted part, being moved to a subsequent robotic cell, in one embodiment.

If the verification was not successful at block 266, a correction is applied. The correction adjusts the movement pattern of the robotic arm to account for the misalignment identified by the final position correction insertion. This type of correction is not an iterative testing and movement process but rather a movement to a computed distance. This eliminates the need for a high frame rate camera to continuously monitor the system.

FIG. 3A is a flowchart of one embodiment of the pick operation. For picking up the part, the system locates the grasping locations for the part. The grasping locations in one embodiment are the handles which are used to safely pick up and move the part. The process starts at block 310.

### Preprocessing Steps:

The 3D imaging element and the robot are preliminary calibrated in respect to the world coordinate system, at block 315. The working plane is determined, at block 320. The working plane defines a bottom of the part location. The process acquires a point cloud to compute the working plane. The system creates a template of the part. In one embodiment, the template is created using a 3D imaging element. The process computes the location of the grasping location from the part origin.

### Runtime Steps:

At block 325, the process acquires a point cloud from the top. FIG. 3C illustrates an exemplary initial point cloud. The process then cleans up the point cloud. In one embodiment, this includes cropping the point cloud to remove irrelevant information (for example the box) and removing the points that are below the known working plane. FIG. 3D illustrates an exemplary cleaned up point cloud, with the box and the areas below the working plane removed. In one embodiment, the point cloud is further decimated, reducing the resolution. In one embodiment, the resolution may be reduced 5-20-fold. In one embodiment, the level of resolution reduction may be based on the size of the grasping area. In one embodiment, the resolution may be reduced differentially across the point cloud, maintaining a high resolution in the area defining the grasping areas, and reducing the resolution in the center area which does not need precise definition for the insertion process.

At block 330, the process matches the template of the part with the point cloud using ICP and a rough location. The rough location can be given, with a measurement provided via manual or other input during setup time, in one embodiment. The rough location can be obtained from measurements from a CAD model, in one embodiment. The rough location can be computed using machine learning, in one embodiment. The rough location can be computed using computer vision, in one embodiment. The process then transforms the six degrees of freedom (6DOF) location of the template into the robot frame using the calibration. The process then computes the location of relevant subparts from the part location. In one embodiment, the relevant subparts include the handles. The locations of the handles/grasping areas are used to pick up the part.

The process determines whether the grasping locations are in the same pose as expected, at block 335. If so, the component is ready to be picked up, and the process ends at block 355.

If the grasping locations are not in the same pose, at block 340 a new point cloud is reacquired. The points below the grasping locations are removed, since the location of the board and its height are known. The remaining point clouds are clustered into distinct clusters at block 345, and the template is matched with the point cloud and compute location, using ICP and a rough location, at block 350. This provides the 6DOF location of handles using the calibration. This results in an accurate identification of the grasping locations for the part. The process then ends at block 355, because the component is ready to be picked up.

FIG. 3B illustrates one embodiment of a Multi-GPU board picked up from the box. Similar configurations may be used for another type of part.

The process identifies the 6DOF location of the handles/grasping locations of the part, which is used to ensure that the part can be safely picked up and moved for insertion into the chassis.

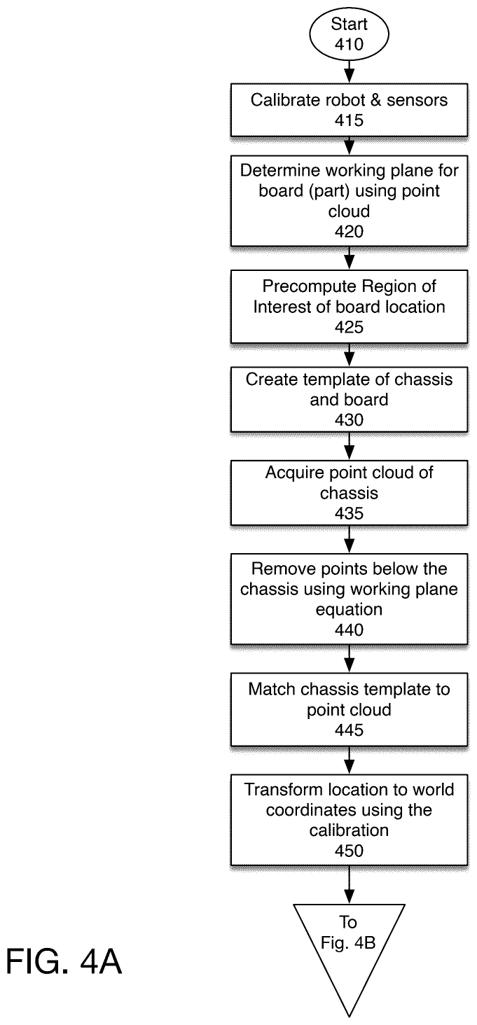

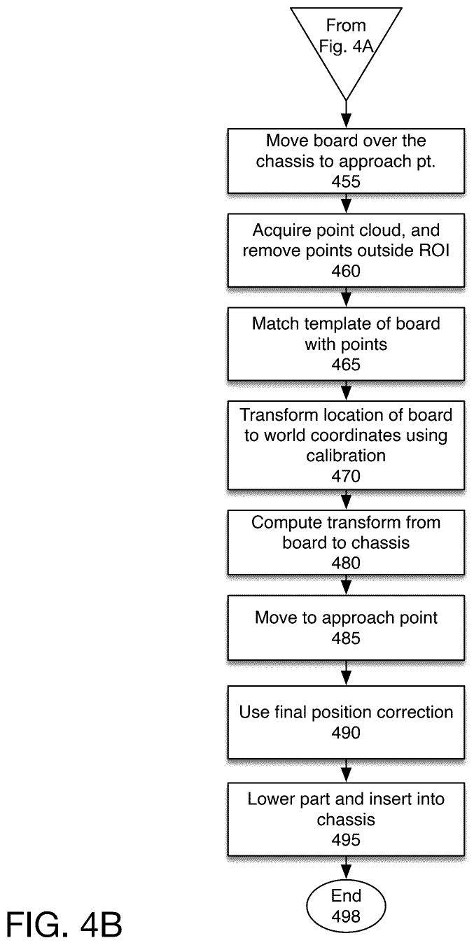

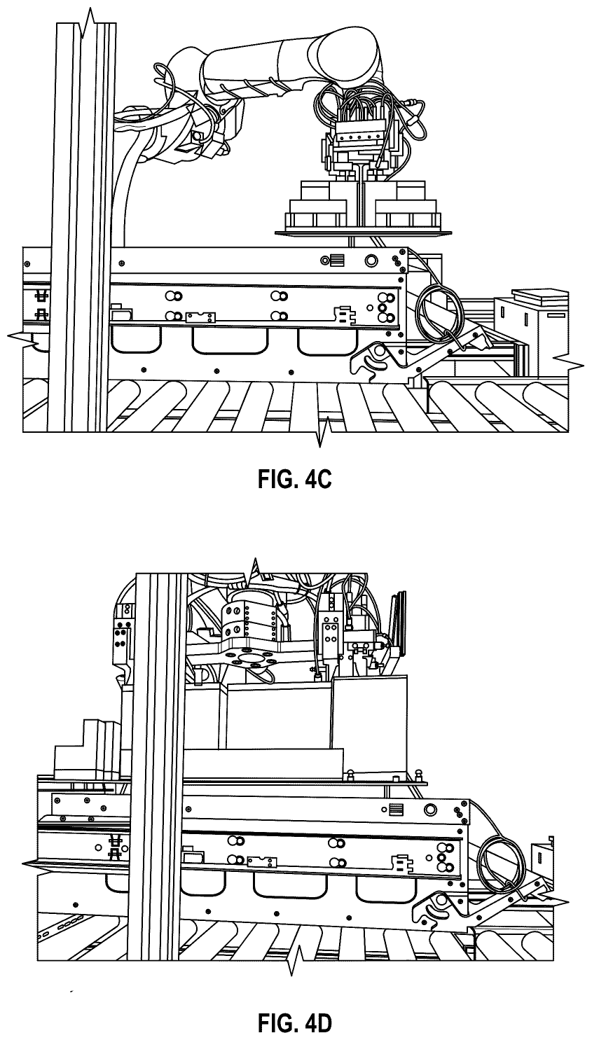

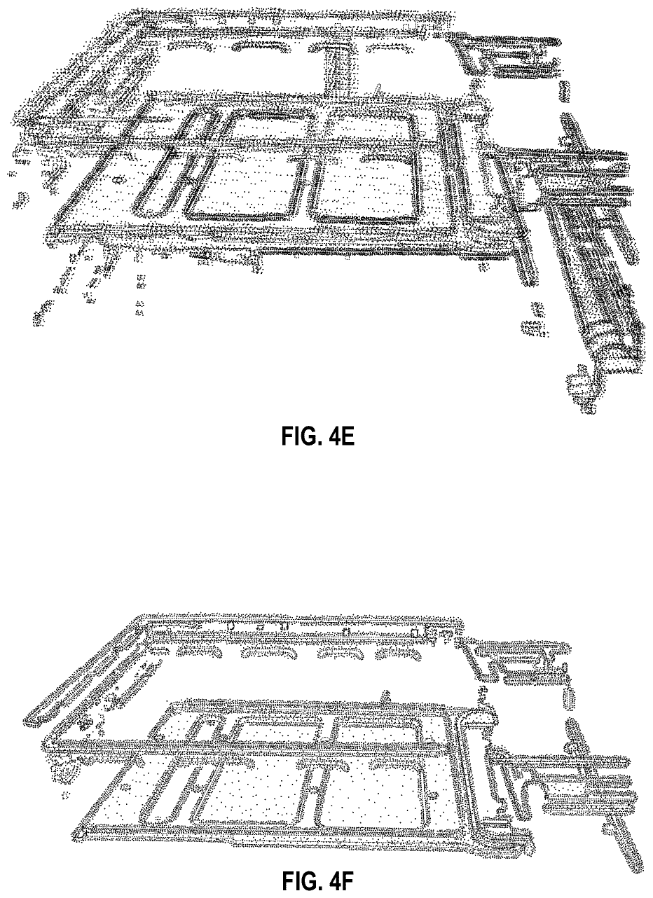

FIG. 4A-4B are a flowchart of one embodiment of the place operation. The place operation places the part, held by the robotic arms into the chassis, and secures it. The process starts at block 410.

The 3D imaging element and the robot will be preliminary calibrated in respect to the world coordinate system, at block 415.

At block 420, the process acquires a point cloud to compute the working plane equation.

At block 425, the process precomputes 3D regions of interest (ROI) of the part. The regions of interest in one embodiment are an identified areas on the chassis which is used to align the part for insertion.

At block 430, the process creates a template of the chassis and a template of the part. In one embodiment, these processes are done in parallel. The ordering of the processes is arbitrary.

When the chassis arrives, the run-time steps are initiated.

The process at block 435 acquires a point cloud from the top of the chassis. FIG. 4E illustrates an exemplary point cloud of the chassis.

At block 440, the process cleans up the point cloud. In one embodiment this includes cropping irrelevant areas and removing the points that are below the chassis using the precomputed plane equation. FIG. 4F illustrates the cleaned up point cloud. This removes a significant portion of the data being stored and manipulated and saves memory as well as processing power. In one embodiment, the point cloud is further decimated by reducing its resolution.

At block 445, the template of the chassis is matched with the chassis points cloud using ICP and a rough location of the chassis.

At block 450, the process transforms the 6DOF location of the templates to the world coordinates of the robotic cell using the calibration. The process continues to block 455.

At block 455, the robotic arm picks up the part using the handles/gripping points identified, and moves it over the chassis, to an approach point which is aligned with the chassis. An exemplary image of the navigation to the approach point is illustrated in FIGS. 4C and 4D. The approach point in one embodiment is positioned directly above the chassis and aligned with the chassis.

When the part arrives at an approach point, to account for the part moving after the position of part was computed during picking further steps are taken. At block 460, the process again acquires a point cloud of the part. In one embodiment, the point cloud is obtained using the 3D imaging element in the place area. The process also removes the points of the point cloud outside the precomputed 3D region of interest bounding box, defining the part. This removes the portions of the point cloud that cover an area outside the part, such as the box in which the part is stored. The bounding box defines a three-dimensional area that contains the part, and the process removes the points that are outside this area. In one embodiment, the point cloud may be further decimated by reducing its resolution.

At block 465, the process matches the template of the part with the point cloud using ICP and a rough location of the part.

At block 470, the process transforms the 6DOF location of the part to the world coordinates of the robotic cell using the calibration.

At block 480, the process computes the transform from the part to the chassis. This transform is used to calculate the motion path planning to move the part to the chassis.

At block 485, the process moves the robotic arm to the corrected the approach point, based on the motion path determined above. In some cases, no correction is needed.

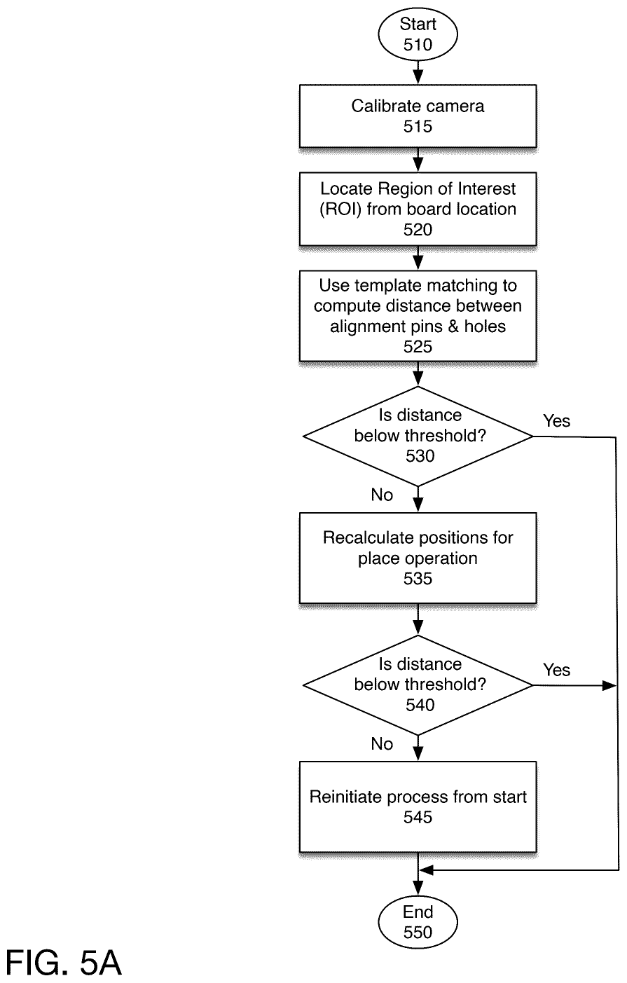

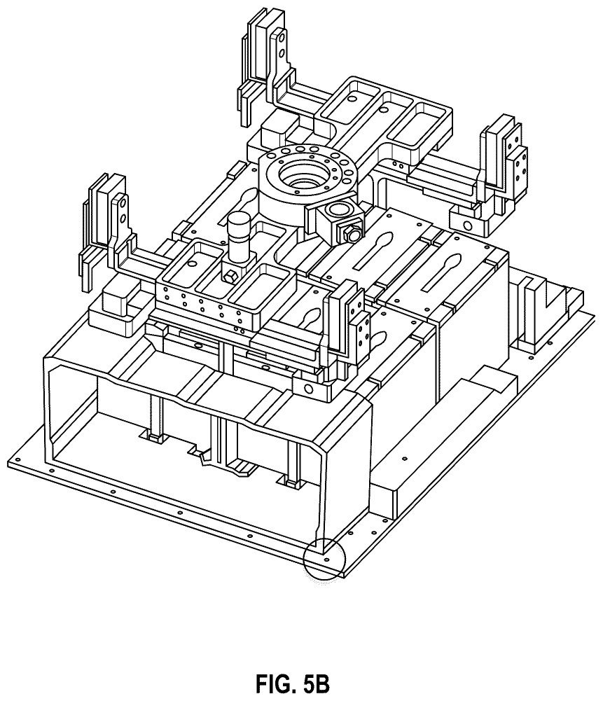

At block 490, the system performs a final position correction just before insertion. The final position correction ensures that the part and chassis are correctly aligned before attempting the insertion. One embodiment of the final position correction just before insertion is described below with respect to FIG. 5A. The part is then ready for insertion. The robotic arm lowers the part and inserts the part into the chassis, at block 495. The process ends at block 498.

FIG. 5A is a flowchart of one embodiment of the position correction just before insertion. The position correction just before insertion is the last validation and correction before insertion of the part into the chassis. It is used to ensure that there is no mismatch, and the part can be inserted without damaging it. The process starts at block 510.

At block 515, the camera is preliminary calibrated with the same system. In one embodiment, this is an end-of-arm camera. In another embodiment, this is a top camera. In one embodiment, this is a pre-processing step that occur at any time prior to the position correction.

At block 520, the process locates the ROI from the board location. FIG. 5B shows a perspective view of the part showing the circled region of interest. The region of interest is an alignment pin, in one embodiment.

At block 525, the process uses template matching to compute the distance between alignment pin and the corresponding motherboard hole.

At block 530, the process determines whether the distance between the alignment pin and the hole is below a threshold. In one embodiment, the threshold is 1000 microns. In another embodiment, the threshold may be +/−500 microns or 250 microns. If the distance is below the threshold, the final position correction just before insertion is unneeded, and the process ends at block 550.

If the distance is not below the threshold, at block 535, the positions for the placement operation are recalculated. The process then determines at block 540, if the distance is now below the threshold, in view of the recalculated positions. If so, the process ends at block 550.

If the distance is still not below the threshold, at block 545, the place process is reinitiated. In one embodiment, the robotic arm returns to an original position, and re-approaches the approach point. In another embodiment, the part is placed back down, and the entire process is initiated from the start. In one embodiment, the system may make more than two attempts to correct, prior to reinitiating the process. The process then ends at block 550.

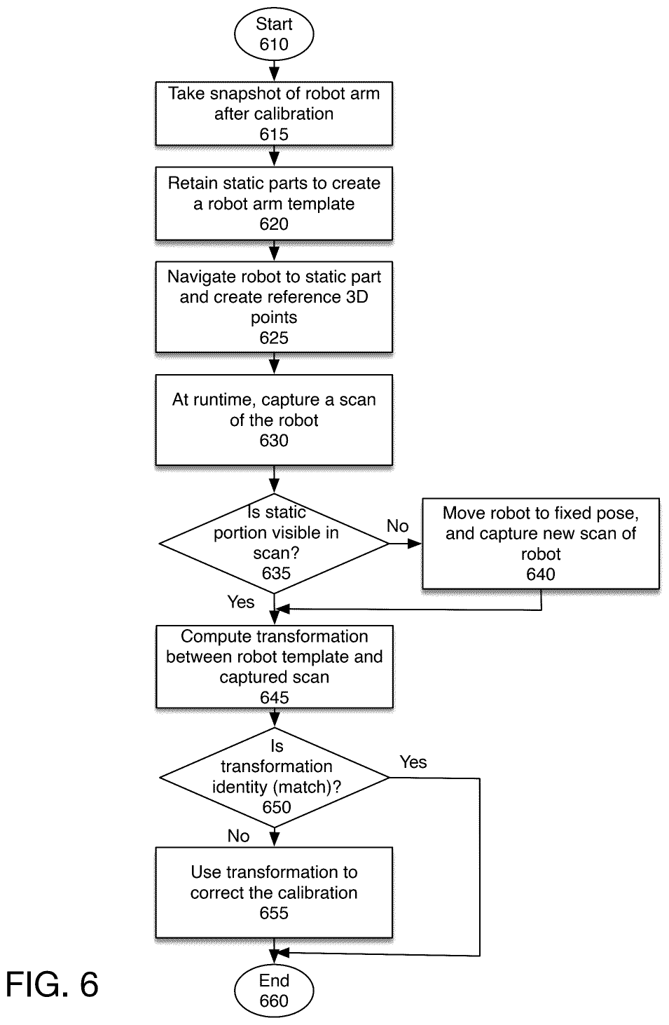

FIG. 6 is a flowchart one embodiment of calibration validation. In one embodiment, this process corresponds to block 254 of FIG. 2C.

Since the sensor will be mounted to a non-rigid platform, the robot calibration can be jeopardized by bumping the mount, a change in temperature, or various other external causes. In one embodiment, the system validates that the calibration is still accurate, prior to attempting to insert the part into the chassis. The validation can also be used as a basis for correcting any errors prior to part insertion. In one embodiment, calibration may be validated each time a part is inserted into the chassis. In one embodiment, calibration may be validated periodically. In one embodiment, calibration may be validated after an insertion attempt fails. The process starts at block 610.

At block 615, after calibration, the process takes a snapshot of the robotic arm. The snapshot in one embodiment is taken with the top camera(s).

At block 620, the image is processed to remove the moving parts and keep only the static part to create a “robot arm template.” The static parts correspond to the non-moving base of the robot arm, in one embodiment. This template is created once, and then used in the validation.

At block 625, the robot is navigated to the static part, and reference 3D points are created for calibration. The reference points are selected to be visible in various configurations. In one embodiment, the system navigates the robot to touch a predetermined number of points to create the reference 3D points. In one embodiment, three 3D reference points are created.

When a validation is triggered, the process captures a scan of the robot. In one embodiment, this is done with the top cameras.

At block 635, the process determines whether the reference 3D points are visible in the scan. If not, at block 640, the robot is moved to a fixed pose which ensures visibility of the reference points. The process then continues to block 645. If the reference points are visible in the initial scan, the process moves directly to block 645.

At block 645, the process computes the transformation between the “robot template” and the “current scan” using ICP. If the calibration remains accurate, the transformation should be identity, e.g., it should match.

At block 650, the process determines whether the transformation is identity to validate the precision of the calibration. If it is, the process ends at block 660. Otherwise, if the transformation is not identity, the system uses the transformation to correct the calibration, at block 655. In one embodiment, the correction needed is above a threshold, the system may initiate a full calibration.

In one embodiment, the robot template may use the non-moving base of the robot, or static robot parts. In another embodiment, an external static part, like a fiducial or a fixed point in the working area is used for the robot template. In another embodiment, the robot arm is moved to a known location, and the robot arm is used as the robot template for this comparison.

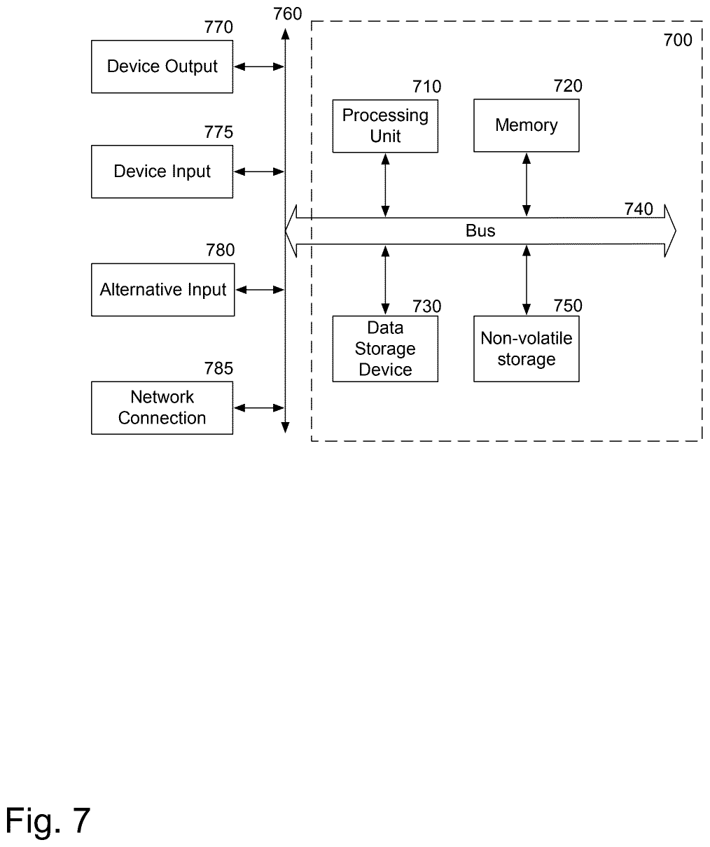

FIG. 7 is a block diagram of one embodiment of a specific purpose computer system which may be used as the processing system for the high precision pick and place system. It will be apparent to those of ordinary skill in the art, however that other alternative systems of various system architectures may also be used.

The computer system illustrated in FIG. 7 includes a bus or other internal communication means 740 for communicating information, and a processing unit 710 coupled to the bus 740 for processing information. The processing unit 710 may be a central processing unit (CPU), a digital signal processor (DSP), graphics processor (GPU), or another type of processing unit 710.

The system further includes, in one embodiment, a memory 720, which may be a random access memory (RAM) or other storage device 720, coupled to bus 740 for storing information and instructions to be executed by processor 710. Memory 720 may also be used for storing temporary variables or other intermediate information during execution of instructions by processing unit 710.

The system also comprises in one embodiment a read only memory (ROM) 750 and/or static storage device 750 coupled to bus 740 for storing static information and instructions for processor 710.

In one embodiment, the system also includes a data storage device 730 such as a magnetic disk or optical disk and its corresponding disk drive, or Flash memory or other storage which is capable of storing data when no power is supplied to the system. Data storage device 730 in one embodiment is coupled to bus 740 for storing information and instructions.

In some embodiments, the system may further be coupled to an output device 770, such as a computer screen, speaker, or other output mechanism coupled to bus 740 through bus 760 for outputting information. The output device 770 may be a visual output device, an audio output device, and/or tactile output device (e.g., vibrations, etc.)

An input device 775 may be coupled to the bus 760. The input device 775 may be an alphanumeric input device, such as a keyboard including alphanumeric and other keys, for enabling a user to communicate information and command selections to processing unit 710. An additional user input device 780 may further be included. One such user input device 780 is cursor control device 780, such as a mouse, a trackball, stylus, cursor direction keys, or touch screen, may be coupled to bus 740 through bus 760 for communicating direction information and command selections to processing unit 710, and for controlling movement on display device 770.

Another device, which may optionally be coupled to computer system 700, is a network device 785 for accessing other nodes of a distributed system via a network. The communication device 785 may include any of a number of commercially available networking peripheral devices such as those used for coupling to an Ethernet, token ring, Internet, or wide area network, personal area network, wireless network, or other method of accessing other devices. The communication device 785 may further be a null-modem connection, or any other mechanism that provides connectivity between the computer system 700 and the outside world.

Note that any or all of the components of this system illustrated in FIG. 7 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 720, mass storage device 730, or other storage medium locally or remotely accessible to processor 710.

It will be apparent to those of ordinary skill in the art that the system, method, and process described herein can be implemented as software stored in main memory 720 or read only memory 750 and executed by processor 710. This control logic or software may also be resident on an article of manufacture comprising a computer readable medium having computer readable program code embodied therein and being readable by the mass storage device 730 and for causing the processor 710 to operate in accordance with the methods and teachings herein.

The computer system 700 may be used to program and configure the robotic cells and provide instructions to the robotic arm. In one embodiment, the computer system 700 is also part of each robotic cell, enabling the robotic cell to execute instructions received in a recipe. The robotic cell is a special purpose appliance including a subset of the computer hardware components described above. For example, the appliance may include a processing unit 710, a data storage device 730, a bus 740, and memory 720, and no input/output mechanisms, except for a network connection to receive the instructions for execution. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 785.

It will be appreciated by those of ordinary skill in the art that any configuration of the particular machine implemented as the computer system may be used according to the particular implementation. The control logic or software implementing the present invention can be stored on a machine-readable medium locally or remotely accessible to processor 710. A machine-readable medium includes any mechanism for storing information in a form readable by a machine (e.g., a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical, or other forms of propagated signals (e.g., carrier waves, infrared signals, digital signals, etc.).

Furthermore, the present system may be implemented on a distributed computing system, in one embodiment. In a distributed computing system, the processing may take place on one or more remote computer systems from the location of an operator. The system may provide local processing using a computer system 700, and further utilize one or more remote systems for storage and/or processing. In one embodiment, the present system may further utilize distributed computers. In one embodiment, the computer system 700 may represent a client and/or server computer on which software is executed. Other configurations of the processing system executing the processes described herein may be utilized without departing from the scope of the disclosure.

In the foregoing specification, the present system has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative rather than a restrictive sense.

We claim:

1. A method for an assembly operation for inserting a part into a chassis, the method comprising:
calculating a first part pose estimation for the part in a pick area;
picking up the part from the pick area using a robot arm, and moving the part above the chassis to an approach point;
calculating a second part pose estimation for the part being held by the robot arm above the chassis;
correcting the second part pose estimation using a chassis pose estimation, thereby performing multi-stage verification;
inserting the part into the chassis, wherein the multi-stage verification ensures that a high value part is not damaged in the assembly.

2. The method of claim 1, further comprising:
applying a final position correction by verifying a position of a fixed region of interest prior to the inserting.

3. The method of claim 2, wherein the final position correction comprises:
locating a region of interest on a board;
using template matching to compute distance between the regions of interest; and
verifying that the distance is below a threshold.

4. The method of claim 1, wherein the calculating the first part pose estimation comprises:
generating a point cloud of the part, using a first sensor;
matching the point cloud to a template of the part; and
computing subpart locations based on the matching.

5. The method of claim 4, further comprising:
defining a working plane, the working plane defining a bottom of the subpart locations; and
removing points in the point cloud below the working plane, prior to the computing.

6. The method of claim 5, further comprising:
clustering the point cloud into distinct clusters; and
matching the subpart locations based on the template of the part and the clusters.

7. The method of claim 1, further comprising performing a calibration verification to verify that sensors remain calibrated, by:
comparing a scan of a static portion of the robot arm to a robot template;
computing a transformation between the robot template and the scan; and
determining that the transformation is identity, to verify the calibration.

8. A high precision pick and place system for inserting a part into a chassis comprising:
run-time pick location computer to calculate a first part pose estimation for the part in a pick area;
a robot arm configured to pick up the part from the pick area and move the part above the chassis to an approach point;
a run-time place location computer further configured to calculate a second part pose estimation for the part being held by the robot arm above the chassis;
a final position corrector to correct the second part pose estimation using a chassis pose estimation, thereby performing multi-stage verification;
the robot arm further configured to insert the part into the chassis, wherein the multi-stage verification ensures that a high value part is not damaged during the insertion.

9. The system of claim 8, further comprising:
the final position corrector to apply position correction just before insertion by verifying a position of a fixed region of interest prior to the inserting.

10. The system of claim 9, wherein the position correction just before insertion comprises:
the final position corrector to locate a region of interest on a board, use template matching to compute distance between the regions of interest, and verify that the distance is below a threshold.

11. The system of claim 8, further comprising:
the run-time pick location computer further configured to:
generate a point cloud of the part, using a first sensor;
match the point cloud to a template of the part; and
compute subpart locations based on the matching.

12. The system of claim 11, further comprising:
the run-time pick location computer to define a working plane, the working plane defining a bottom of the subpart locations; and
the run-time pick location computer to remove points in the point cloud below the working plane, prior to the computing.

13. The system of claim 12, further comprising:
the run-time pick location computer further to cluster the point cloud into distinct clusters and match the subpart locations based on the template of the part and the clusters.

14. The system of claim 8, further comprising:
a calibration validator to perform a calibration verification to verify that sensors remain calibrated, by comparing a scan of a static portion of the robot arm to a robot template, computing a transformation between the robot template and the scan, and determining that the transformation is identity, to verify the calibration.

15. A method for an assembly operation for inserting a part into a chassis, the method comprising:
picking up the part from a pick area using a robot arm;
moving the part above the chassis to an approach point;
calculating a part pose estimation for the part being held by the robot arm at the approach point, based on data from one or more sensors;
verifying that the part pose estimation matches an intended part pose;
matching the part pose estimation to a chassis pose estimation;
applying a final position correction just before inserting the part by verifying a position of a fixed region of interest prior to the inserting; and
inserting the part into the chassis, wherein the method ensures that a high value part is not damaged in the assembly.

16. The method of claim 15, wherein the final position correction comprises:
locating a region of interest on a board;
using template matching to compute distance between the regions of interest; and
verifying that the distance is below a threshold.

17. The method of claim 15, wherein the calculating a part pose estimation comprises:
generating a point cloud of the part, using a first sensor;
matching the point cloud to a template of the part; and
computing subpart locations based on the matching.

18. The method of claim 17, further comprising:
defining a working plane, the working plane defining a bottom of the subpart locations; and
removing points in the point cloud below the working plane, prior to the matching.

19. The method of claim 18, further comprising:
decimating the point cloud prior to the matching, to reduce a resolution.

20. The method of claim 15, further comprising performing a calibration verification to verify that sensors remain calibrated, by:
comparing a scan of a static portion of the robot arm to a robot template;
computing a transformation between the robot template and the scan; and
determining that the transformation is identity to verify the calibration.
